(19) United States
(12) Patent Application Publication
(10) Pub. No.: US 2005/0080526 A1
(43) Pub. Date: Apr. 14, 2005

(54) Audible warning device for a motorcycle

(76) Inventors: George P. Williams, Pittsburgh, PA (US); Brandon D. Tusing, Ruffsdale, PA (US)

Correspondence Address: Donald M. Satina, 902 Broadway Ave., McKees Rocks, PA, 15136, US

(21) Appl. No.: 10/685,212

(22) Filed: Oct. 14, 2003

(51) Int. Cl. G06F 19/00

(52) U.S. Cl. 701/29; 701/36

(57) ABSTRACT

The present invention is adapted to sound an audible alarm if the operator of a motorcycle stops the engine with the shut off switch and leaves the ignition on. The alarm will sound once the oil pressure falls to 0 or below a predetermined level. The present invention is also useful for notifying the operator of a loss of oil pressure during operation, indicating either that the engine has stopped running, such as by stalling, or oil pressure has dropped below the minimum safe operating level due to a leak or mechanical defect. The invention is also useful during startup of a motorcycle to warn of a problem with the lubrication system. When the engine is started, the oil pressure audible alarm will sound until the engine oil pressure has exceeded the minimum pressure.

### BACKGROUND OF THE INVENTION

The invention relates to instrumentation for detecting certain harmful operating conditions of a vehicle operable by an internal combustion engine, such as a motorcycle, and for providing the operator with an audible warning of the harmful condition. More particularly, the invention warns the operator that the ignition switch has been left on, preventing a dead battery by monitoring the engine oil pressure and the position of certain switches. The invention also has utility for warning the operator of a low oil pressure condition to prevent engine damage.

Internal combustion engines for automobiles, watercraft and motorcycles are usually equipped with a sensor for detecting low oil pressure and a warning light for alerting the operator. Some automobiles and watercraft are also equipped with auditory alarms for annunciating a low oil pressure condition. These alarms are designed to produce an alarm only when the engine is operating to notify the operator of a loss of oil pressure due to a drop in oil level or stall condition of the engine.

Motorcycles, automobiles and watercraft usually have an ignition switch operable only with a key unique to the vehicle. However, motorcycles are different from automobiles and watercraft in that all motorcycles also have an emergency engine shutoff switch, also known as a “kill switch”, mounted on the handlebars as a safety feature. In order to start a motorcycle, the shutoff switch must be in the “run” position and the ignition switch must be in the “on” position. However, a motorcycle engine can be shut off by either turning off the ignition switch with the key or moving the engine shutoff switch to the “off” position.

A problem unique to motorcycles can arise due to the ability to shut off the engine without turning off the ignition switch. When a motorcycle operator parks his motorcycle, he should turn off the ignition switch. However, operators sometimes use the shutoff switch to “kill” the engine, leaving all other systems on the motorcycle active. Due to Federal safety mandates in the 1980's, motorcycles are required to operate with their headlights on at all times, including daylight hours. Therefore, manufacturers have modified motorcycle wiring so that the headlights are on any time the ignition switch is turned on. If the operator merely stops the engine by turning the shut off switch to the “off” position, the ignition switch remains active and the headlights remain on. During daylight hours, the operator might not notice that the headlights and other indicator lights are on. If he walks away from the motorcycle for a long enough period of time, his battery will be dead when he returns.

Most larger motorcycles with an electric starter are equipped with a 12 volt electrical system. Automobiles have 12 volt electrical systems but have very high voltage systems in comparison to a motorcycle. Since it is often not possible to push start or drift start a larger motorcycle, the operator of such a motorcycle with a dead battery would logically try to start the vehicle from an automobile battery using jumper cables. Due to the much higher voltage of the automobile electrical system, the motorcycle will experience damage to the ignition system, on-board computer, coil and/or other electrical system components.

If an operator is warned that the ignition switch has been left on, a dead battery can be prevented and the vehicle owner will have no reason to jump start the motorcycle, avoiding damage to electrical system components.

### SUMMARY OF THE INVENTION

An audible warning system for use on a motorcycle having a battery, an ignition switch operable between an on and off position, an engine shutoff switch operable between a run and off position, and an oil pressure switch operable to close at levels of oil pressure below a predetermined level, the audible warning system comprising the oil pressure switch and an alarm adapted to produce an audible signal in the event the oil pressure switch is closed with the ignition switch in the on position. The alarm can be selected from the group of alarm devices comprising sirens, bells, buzzers, horns, whistles, beepers, chimes, buzzers, and electronic voice synthesizers.

The audible warning system may further comprise a second alarm adapted to produce a second audible signal in response to the closing of the oil pressure switch with the ignition switch in the on position and the engine shutoff switch in the off position, thereby warning that the ignition key has been left in the on position. This second alarm can be selected from the group of alarm devices comprising sirens, bells, buzzers, horns, whistles, beepers, chimes, buzzers, and electronic voice synthesizers with the second audible signal being different from the first audible signal. In this embodiment, the second alarm signal is preferably a recorded message warning that the key has been left on.

Also described is an audible warning system for use on a motorcycle having a battery, an ignition switch operable between an on and off position, an engine shutoff switch operable between a run and off position, and an oil pressure switch operable to close at levels of oil pressure below a predetermined level, the audible warning system comprising the oil pressure switch and an alarm adapted to produce an audible signal in the event the oil pressure switch is closed with the ignition switch in the on position and the shut off switch in the off position. The alarm can be selected from the group of alarm devices comprising sirens, bells, buzzers, horns, whistles, beepers, chimes, buzzers, and electronic voice synthesizers.

In one embodiment, the audible warning system is adapted to be easily retrofitted onto a motorcycle having a battery, an ignition switch operable between an on and off position, an engine shutoff switch operable between a run and off position, an oil pressure switch operable to close at levels of oil pressure below a predetermined level, and an oil pressure warning light. The oil pressure warning light is connected by wires to the oil pressure switch and the oil pressure warning light will to be illuminated when the oil pressure switch closes. In this embodiment, the audible warning system includes the oil pressure switch, the wires and an alarm adapted to produce an audible signal in the event the oil pressure switch is closed with the ignition switch in the on position. The alarm can be attached to the wires for the oil pressure warning light.

### BRIEF DESCRIPTION OF THE DRAWINGS

FIG. 1 illustrates the basic configuration of ignition wiring on a typical motorcycle.

FIG. 2 illustrates the preferred embodiment of the present invention comprising ignition wiring for a motorcycle incorporating an audible warning device.

FIG. 3 illustrates a second embodiment of the invention including multiple, audible alarms having distinctive sounds.

FIG. 4 illustrates a further embodiment of the invention wherein the audible alarm sounds only to warn the operator that the ignition has been left in the on condition with the engine shut off.

### DETAILED DESCRIPTION OF THE INVENTION

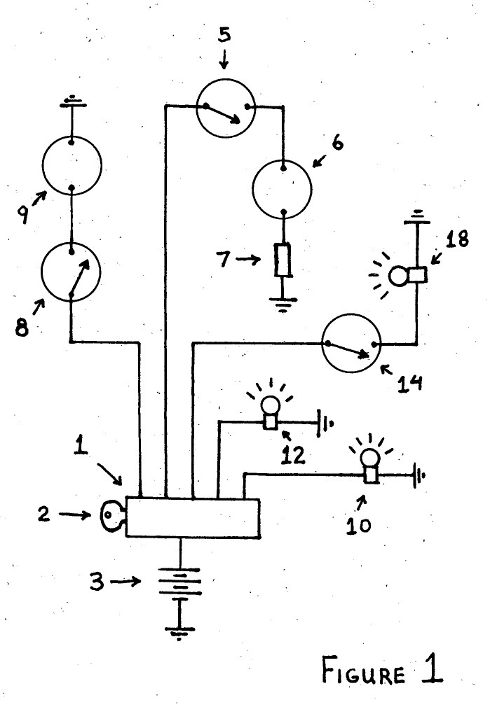

FIG. 1 depicts the typical basic wiring layout of a motorcycle. An ignition switch 1 is adapted to receive a unique key 2, permitting the switch 1 to operate between an “on” position during which all systems of the motorcycle are operational, and an “off” position. Electrical power from the battery 3 must flow through the ignition switch 1 to reach other electrical components. For example, electric power travels through engine shut off switch 5, usually mounted on the handlebars, to coil 6 and to spark plug 7. Shut off switch 5 is operable between an “on” or “run” position and an “off” or “engine stop” position. Shut off switch 5 can be used to quickly shut off the engine, such as in the case of an emergency, and is often referred to as a “kill switch”. Shut off switch 5 operates to stop the engine by interrupting the flow of electricity from the battery to the coil 6. With the ignition switch in the “on” position and the shutoff switch 5 in the “run” position, the operator may depress the starter button 8, providing power to the starter 9 to rotate and start the engine. Shutoff switch 5 stops the engine but does not disable other electrical systems, such as the headlight 10, tail light (not shown), radio (not shown), and so on.

An oil pressure switch 14 is mounted on the engine crankcase and detects the oil pressure. When the engine is not running, the oil pressure will be zero (0) and the oil pressure switch 14 will be in the closed position. When the engine is started, the oil pressure will rise. Oil pressure switch 14 is pressure activated and will open when the oil pressure reaches a predetermined level. Low oil pressure warning light 18 is connected to oil pressure switch 14. When the ignition switch 1 is activated by turning key 2 to the “on” position, power from the battery 3 flows through closed oil pressure switch 14 and lights warning light 18. With shut off switch 5 in the “run” position, the operator can now start the motorcycle engine by depressing the starter button 8. After several seconds, the engine oil pressure will exceed the predetermined minimum oil pressure level for the selected oil pressure switch 14, and switch 14 will open, stopping the flow of power from the battery 3 to the warning light 18 and warning light 18 will go off.

After the engine has reached normal operating conditions, several circumstances can lead to warning light 18 being turned back on. If the engine experiences a problem during operation with the lubrication system, such as a loss of oil due to a leak, oil pump failure or other reasons, causing the oil pressure to drop below the minimum oil pressure for oil pressure switch 14, switch 14 will close, turning on warning light 18. If the engine stops running, such as by stalling, the oil pressure will quickly drop below the minimum oil pressure for oil pressure switch 14, closing switch 14 and illuminating oil light 18. Also, if shut off switch 5 is turned to the “off” position with ignition switch 1 in the “on” position, the engine will stop immediately and the oil pressure will drop below the minimum oil pressure for oil pressure switch 14 and, since ignition switch 1 is in the “on” position, warning light 18 will be turned on.

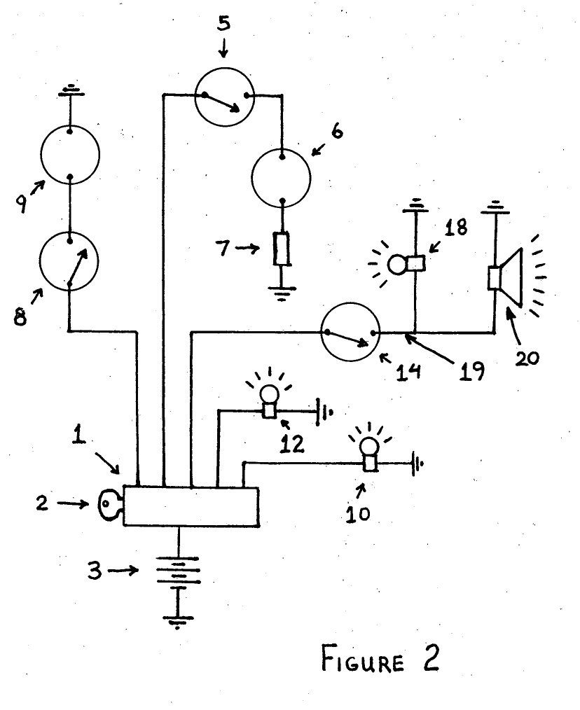

FIG. 2 illustrates the typical basic wiring layout for a motorcycle equipped with an audible alarm 20 according to a preferred embodiment of the invention. In this most basic form of the invention, audible alarm 20 is activated under the same conditions as low oil pressure warning light 18. In this embodiment, audible alarm 20 can be wired into the circuit in parallel with warning light 18. When the engine is experiencing a low oil pressure condition, such as during engine start up, low oil pressure switch 14 will be in the closed position, supplying power from battery 3 to both warning light 18 and audible alarm 20, activating audible alarm 20 in addition to warning light 18. Audible alarm 20 must be capable of emitting a sound loud enough for the operator to hear, even with the engine running. Examples of suitable devices for the audible alarm 20 are sirens, whistles, chimes, beepers, buzzers, bells, horns, and other devices capable of emitting an audible sound. A preferred alarm 20 is an electronic beeper available from any electronics supply store. Audible alarm 20 can be of a preset volume or can have an adjustable volume control and will preferably produce a sound at a level of 50 dB or higher. In the embodiment of the invention depicted in FIG. 2, audible alarm 20 can be easily retrofitted onto a motorcycle by splicing into the wire 19 that supplies current to warning light 18.

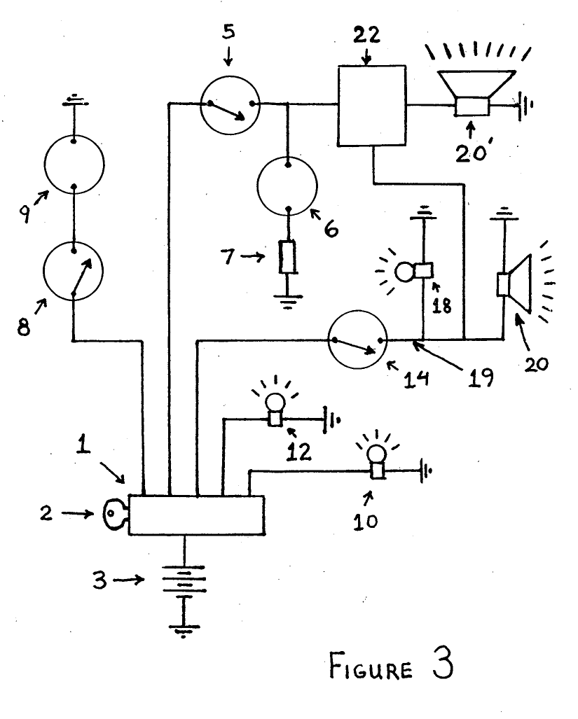

FIG. 3 depicts an alternative embodiment of the invention in which embodiment, two or more different audible alarms 20 and 20′, are used to alert the operator of different conditions. For example, if oil pressure switch 14 is closed with shut off switch 5 in the “run” position, a first audible alarm will warn of a low oil pressure condition. When the oil pressure switch 14 is closed with the shut off switch in the “off” position, a second audible alarm will warn the operator that the ignition has been left in the “on” position. The second audible alarm can be any distinctive sound or it can be a verbal message, recorded or synthesized. A preferred second audible alarm device 20′ is an electronic voice synthesizer of the type available at most electronics supply stores. These devices permit the operator to record a message for broadcast. An exemplary message would be “You left your key on”. This embodiment requires a comparator 22 to determine whether shut off switch 5 is in the “run” position, indicating a potential problem with the lubrication system, or the “off” position, indicative of shutting off the engine but leaving the ignition key in the “on” position. A preferred comparator is a solid state device available at electronics supply stores. In this embodiment, audible alarm 20 will sound anytime the oil pressure drops below the predetermined minimum level for oil pressure switch 14 and second audible alarm 20′ will also sound if shut off switch 5 is in the “off” position but not if shut off switch 5 is in the “run” position.

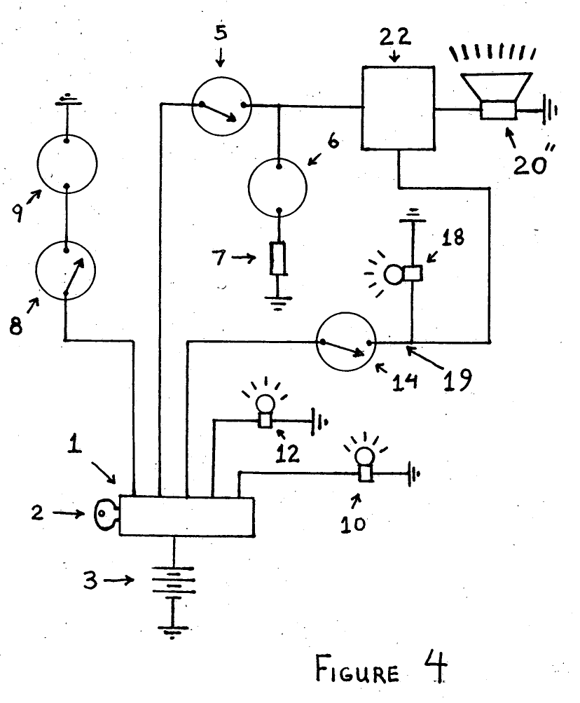

FIG. 4 depicts a third embodiment of the invention. In this embodiment, audible alarm will be sounded only when the oil pressure switch 14 is closed with the shut off switch 5 in the “off” position. In this embodiment, the invention functions only as a warning that the operator left the ignition key in the “on” position. Voltage supplied by battery 3 will cause current to flow through ignition switch 1, through oil pressure switch 14 and to comparator 22. If shutoff switch 5 is in the “off” position, comparator 22 will permit the flow of current to second alarm 20″, sounding alarm 20″ to warn the operator that the ignition key has been left on. Low oil pressure warning will be left to the warning light 18. Audible alarm 20″ can be any distinctive sound or a verbal message. Preferably, audible alarm 20″ is an electronic voice synthesizer. As described in above for the embodiment of FIG. 3, warning that the key has been left on. In this embodiment, only oil light 18 is used to signal the operator of low oil pressure conditions during start up and normal operation.

The invention has been described above in relation to several preferred embodiments. Other embodiments of the invention will be contemplated by those skilled in the art and are not excluded.

1. An audible warning system for use on a motorcycle having a battery, an ignition switch operable between an on and off position, an engine shutoff switch operable between a run and off position, and an oil pressure switch operable to close at levels of oil pressure below a predetermined level, said audible warning system comprising said oil pressure switch and an alarm adapted to produce an audible signal in the event the oil pressure switch is closed with said ignition switch in the on position.

2. The audible warning system of claim 1, wherein said alarm is selected from the group of alarm devices comprising sirens, bells, buzzers, horns, whistles, beepers, chimes, buzzers, and electronic voice synthesizers.

3. The audible warning system of claim 1, further comprising a second alarm adapted to produce a second audible signal in response to the closing of said oil pressure switch with said ignition switch in the on position and said engine shutoff switch in the off position, thereby warning that said ignition switch has been left in the on position.

4. The audible warning system of claim 3, further comprising a comparator adapted to supply current to said second alarm if said engine shutoff switch is in the off position.

5. The audible warning system of claim 3, wherein said second alarm is selected from the group of alarm devices comprising sirens, bells, buzzers, horns, whistles, beepers, chimes, buzzers, and electronic voice synthesizers, said second audible signal being different from said audible signal.

6. The audible warning system of claim 5, wherein said second alarm signal comprises a recorded message warning that said ignition switch has been left on.

7. An audible warning system for use on a motorcycle having a battery, an ignition switch operable between an on and off position, an engine shutoff switch operable between a run and off position, and an oil pressure switch operable to close at levels of oil pressure below a predetermined level, said audible warning system comprising said oil pressure switch and an alarm adapted to produce an audible signal in the event said oil pressure switch is closed with said ignition switch in the on position and said shut off switch in the off position.

8. The audible warning system of claim 7, further comprising a comparator adapted to supply current to said alarm if said engine shutoff switch is in the off position.

9. The audible warning system of claim 7, wherein said alarm is selected from the group of alarm devices comprising sirens, bells, buzzers, horns, whistles, beepers, chimes, buzzers, and electronic voice synthesizers.

10. An audible warning system adapted to be retrofitted onto a motorcycle having a battery, an ignition switch operable between an on and off position, an engine shutoff switch operable between a run and off position, an oil pressure switch operable to close at levels of oil pressure below a predetermined level, and an oil pressure warning light, said oil pressure warning light being connected by wires to said oil pressure switch, said oil pressure warning light adapted to be illuminated when said oil pressure switch closes, said audible warning system comprising said oil pressure switch, said wires and an alarm adapted to produce an audible signal in the event said oil pressure switch is closed with said ignition switch in the on position, said alarm being adapted to be attached to said wires for said oil pressure warning light.

11. The audible warning system of claim 10, wherein said alarm is selected from the group of alarm devices comprising sirens, bells, buzzers, horns, whistles, beepers, chimes, buzzers, and electronic voice synthesizers.
